(19) United States
(12) Patent Application Publication
(10) Pub. No.: US 2024/0021360 A1
(43) Pub. Date: Jan. 18, 2024

(54) ELECTRONIC COMPONENT

(71) Applicant: Murata Manufacturing Co., Ltd., Kyoto-fu (JP)

(72) Inventor: Yuuta HOSHINO, Nagaokakyo-shi (JP)

(73) Assignee: Murata Manufacturing Co., Ltd., Kyoto-fu (JP)

(21) Appl. No.: 18/352,937

(22) Filed: Jul. 14, 2023

Related U.S. Application Data
(63) Continuation of application No. PCT/JP2021/044983, filed on Dec. 7, 2021.

(30) Foreign Application Priority Data
Feb. 1, 2021 (JP) 2021-014489

(51) Int. Cl. H01F 27/32; H01F 1/36; H01F 27/29; H01F 17/00

(52) U.S. Cl. CPC H01F 27/324; H01F 1/36; H01F 27/292; H01F 17/0013

(57) ABSTRACT

An electronic component includes a ceramic base containing a Cu element; an insulating film containing glass and at least partially covering a surface of the base; and a Cu segregate containing a Cu element. The Cu segregate is in contact with the base and the insulating film at an interface between the base and the insulating film.

### CROSS-REFERENCE TO RELATED APPLICATIONS

This application claims benefit of priority to International Patent Application No. PCT/JP2021/044983, filed Dec. 7, 2021, and to Japanese Patent Application No. 2021-014489, filed Feb. 1, 2021, the entire contents of each are incorporated herein by reference.

### BACKGROUND

### Technical Field

The present disclosure relates to an electronic component.

### Background Art

A known multilayer coil component includes an insulating film containing glass formed on the surface of a base made of a ferrite sintered body.

Japanese Unexamined Patent Application Publication No. 2017-204565 discloses a multilayer coil component including a base made of a ferrite sintered body and a coil constituted by electrically coupling a plurality of inner conductors juxtaposed in the base, wherein a surface of the base is covered with an insulating layer containing glass.

### SUMMARY

However, the multilayer coil component described in Japanese Unexamined Patent Application Publication No. 2017-204565 has poor adhesion between the base and the insulating layer (insulating film) and has room for improvement in the adhesion.

The present disclosure provides an electronic component with high adhesion between a base and an insulating film.

One embodiment of an electronic component according to the present disclosure includes a ceramic base containing a Cu element; an insulating film containing glass and at least partially covering a surface of the base; and a Cu segregate containing a Cu element, wherein the Cu segregate is in contact with the base and the insulating film at an interface between the base and the insulating film.

The present disclosure can provide an electronic component with high adhesion between a base and an insulating film.

### BRIEF DESCRIPTION OF THE DRAWINGS

FIG. 1 is a schematic perspective view of one example of an electronic component according to an embodiment of the present disclosure;

FIG. 2 is a cross-sectional view taken along the line II-II of FIG. 1;

FIG. 3 is a schematic perspective view of another example of an electronic component according to an embodiment of the present disclosure;

FIG. 4 is a cross-sectional view taken along the line IV-IV of FIG. 3;

FIG. 5 is a schematic cross-sectional view of one example of the state of an interface between a base and an insulating film in one embodiment of an electronic component according to the present disclosure;

FIG. 6 is a schematic cross-sectional view of another example of the state of an interface between a base and an insulating film in one embodiment of an electronic component according to the present disclosure;

FIG. 7 is a schematic cross-sectional view of still another example of the state of an interface between a base and an insulating film in one embodiment of an electronic component according to the present disclosure;

FIG. 8 is an elemental mapping image of Cu at an interface between a base and an insulating film of an electronic component according to Example 2;

FIG. 9 is an elemental mapping image of Cu at the interface between the base and the insulating film of the electronic component according to Example 2; and

FIG. 10 is an elemental mapping image of Cu at the interface between the base and the insulating film of the electronic component according to Example 2.

### DETAILED DESCRIPTION

An electronic component according to the present disclosure is described below.

However, the present disclosure is not limited to the following embodiments, and various modifications may be made in them without departing from the gist of the present disclosure.

It goes without saying that the following embodiments are illustrative, and structures described in different embodiments can be partially replaced or combined. In the second embodiment and subsequent embodiments, matters common to the first embodiment are not described, and only different points are described. In particular, the same operational advantages of the same structure are not described in each embodiment.

Drawings shown below are schematic and may have the dimensions, the scale of the aspect ratio, and the like different from those of actual products.

One embodiment of an electronic component according to the present disclosure includes a ceramic base containing a Cu element; an insulating film containing glass and at least partially covering a surface of the base; and a Cu segregate containing a Cu element. The Cu segregate is in contact with the base and the insulating film at an interface between the base and the insulating film.

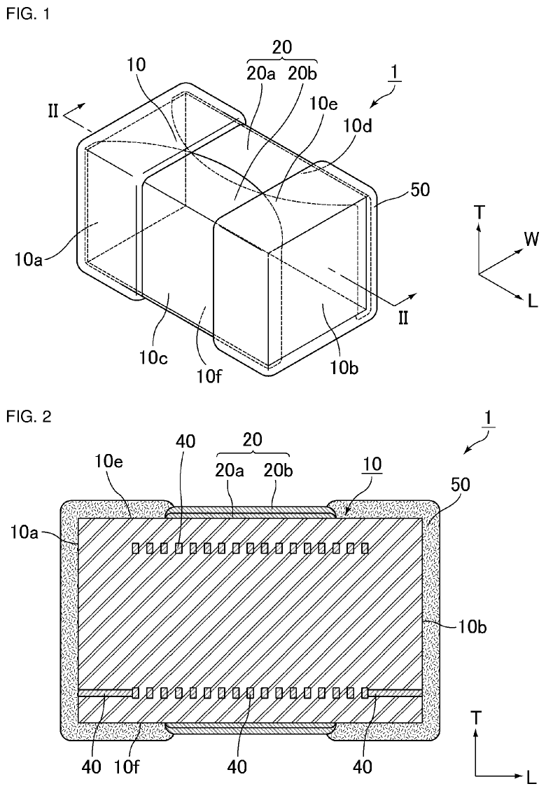

FIG. 1 is a schematic perspective view of one example of an electronic component according to an embodiment of the present disclosure.

An electronic component 1 illustrated in FIG. 1 includes a base 10 and an insulating film 20 partially covering the surface of the base 10.

The base 10 has an approximately rectangular parallelepiped shape with a first end face 10a and a second end face 10b that face each other in the length direction L, with a first side surface 10c and a second side surface 10d that face each other in the width direction W perpendicular to the length direction L, and with an upper surface 10e and a bottom surface 10f that face each other in the thickness direction T perpendicular to the length direction L and to the width direction W.

The insulating film 20 includes: an insulating film 20a entirely covering the second side surface 10d of the base 10 and partially covering the first end face 10a, the second end face 10b, the upper surface 10e, and the bottom surface 10f; and an insulating film 20b entirely covering the first side surface 10c of the base 10 and partially covering the first end face 10a, the second end face 10b, the upper surface 10e, and the bottom surface 10f.

On the upper surface 10e and the bottom surface 10f of the base 10, the insulating film 20a and the insulating film 20b are provided so as to partially overlap each other.

The number of the insulating films covering the surface of the base may be one or three or more. For example, the surface of the base may be entirely covered with one or a plurality of insulating films, except for a portion where a conductor layer described later is exposed on the surface of the base.

An outer electrode 50 is provided on the surface of the base 10.

The outer electrode 50 is provided so as to cover the first end face 10a and the second end face 10b of the base 10. The outer electrode 50 covering the first end face 10a of the base 10 is partially formed so as to partially surround the first side surface 10c, the second side surface 10d, the upper surface 10e, and the bottom surface 10f of the base 10. The outer electrode 50 covering the second end face 10b of the base 10 is partially formed so as to partially surround the first side surface 10c, the second side surface 10d, the upper surface and the bottom surface 10f of the base 10.

The surface of the base 10 is partially covered with the insulating film 20 (20a, 20b), and a portion of the surface of the base 10 not covered with the insulating film 20 is covered with the outer electrode 50. Thus, the surface of the base 10 is not exposed. The surface of the base may be partially exposed without being covered with the insulating film or the outer electrode.

FIG. 2 is a cross-sectional view taken along the line II-II of FIG. 1.

As illustrated in FIG. 2, the base 10 has a conductor layer 40 inside. The conductor layer 40 is exposed at the first end face 10a and the second end face 10b of the base 10 and is electrically coupled to the outer electrode 50. The conductor layer 40 forms a coil as a whole. The coil axis of a coil formed by the conductor layer 40 is parallel to the length direction L.

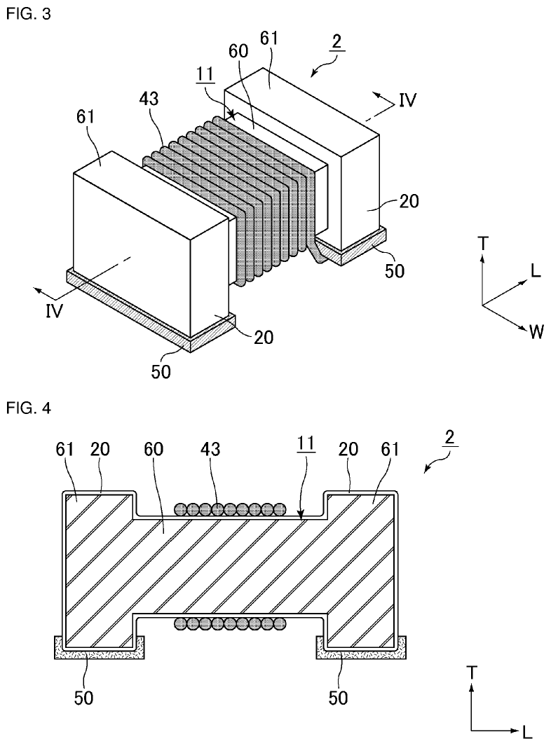

FIG. 3 is a schematic perspective view of another example of an electronic component according to an embodiment of the present disclosure.

An electronic component 2 illustrated in FIG. 3 includes a base 11 and an insulating film 20 partially covering the surface of the base 11. The base 11 has a barbell shape with a columnar wound core portion 60 wound with a winding wire 43, and with a flange 61 coupled to both end portions of the wound core portion 60 in the length direction L. The winding wire 43 is wound around the wound core portion 60 of the base 11.

FIG. 4 is a cross-sectional view taken along the line Iv-Iv of FIG. 3.

As illustrated in FIG. 4, the insulating film 20 entirely covers the flange 61 of the base 11 and the wound core portion 60. The surface of the base 11 is entirely covered with the insulating film 20, and the winding wire 43 is therefore not in contact with the base 11. Although not shown in the figure, an end portion of the winding wire 43 is coupled to the outer electrode 50.

In the electronic component 2 illustrated in FIGS. 3 and 4, the surface of the base 11 is entirely covered with the insulating film 20, and the winding wire 43 is therefore not in contact with the base 11. The number of the insulating films covering the surface of the base is not particularly limited, and the surface of the base may be covered with two or more insulating films.

### [Base]

In one embodiment of an electronic component according to the present disclosure, the base is a ceramic containing a Cu element.

Examples of the ceramic containing a Cu element include known ceramics, such as ferrite, alumina, barium titanate, and Zn ceramics, containing a Cu element.

The ceramic containing a Cu element may contain an additive agent, such as Mn₃O₄, Co₃O₄, SnO₂, Bi₂O₃, or SiO₂.

The base preferably has a Cu element content of 6% by mole or more and 10% by mole or less (i.e., from 6% by mole to 10% by mole).

The Cu element content of the base does not include the Cu element constituting the Cu segregate on the surface of the base.

The Cu element content of the base can be measured as a value from which the influence of segregation is eliminated by polishing the base to expose a cross section of 10 μm or more inside from the surface of the base and performing wavelength-dispersive X-ray fluorescence (WD-XRF) measurement with a spot diameter of φ1 μm or more. The WD-XRF measurement may be performed on approximately five samples to further reduce the variation depending on the measurement point.

The Fe element content of the base is preferably 40% by mole or more and 49.5% by mole or less (i.e., from 40% by mole to 49.5% by mole) in terms of Fe₂O₃.

The Ni/Zn mole ratio of the base is preferably, but not limited to, 1.8 or more and 2.8 or less (i.e., from 1.8 to 2.8).

The shape of the base is, for example, but not limited to, a cubic shape, a rectangular parallelepiped shape, a barbell shape, an H shape, an I shape, or an annular shape.

Although the base may have any external dimensions, a smaller base has a smaller contact area between the base and the insulating film and significantly makes it difficult to improve the adhesion between the base and the insulating film.

For example, the external dimensions of the base are preferably 5.7 mm or less in length×5.0 mm or less in width×5.0 mm or less in height, particularly preferably 1.6 mm or less in length×0.8 mm or less in width×0.8 mm or less in height.

The base may have a conductor layer inside.

A conductor layer formed inside the base may form a passive element, such as a coil, a capacitor, a resistor, or a thermistor. A plurality of passive elements may be formed inside the base.

A passive element formed inside the base may have any orientation. Thus, the coil axis of a coil formed inside the base may be horizontal or vertical to the component side of an electronic component. Furthermore, the number of coils formed inside the base may be one or two or more.

An electronic component according to the present disclosure including a coil formed in the base is, for example, a multilayer coil component and, depending on the type of passive element constituted by a conductor layer, may be a multilayer capacitor component, a multilayer resistance component, a multilayer thermistor component, or the like.

The base may have no conductor layer inside.

In such a case, the base can be wound with a winding wire and can also be used as a wound core.

An electronic component according to the present disclosure including the base wound with a winding wire is, for example, a wound coil component. The number of coils formed by winding a winding wire around the base may be one or two or more.

### [Insulating Film]

In one embodiment of an electronic component according to the present disclosure, the insulating film at least partially covers the surface of the base.

The insulating film contains glass.

Examples of the glass constituting the insulating film include B—Si glass, Ba—B—Si glass, B—Si—Zn glass, B—Si—Zn—Ba glass, and B—Si—Zn—Ba—Ca—Al glass. In addition to these, alkali metal glasses, such as Na—Si glass, K—Si glass, and Li—Si glass; alkaline-earth metal glasses, such as Mg—Si glass, Ca—Si glass, Ba—Si glass, and Sr—Si glass; and Ti—Si glass, Zr—Si glass, and Al—Si glass can also be used.

The glass may be crystalline glass.

The weight ratio of the glass in the insulating film is preferably, but not limited to, 90% by weight or more.

The thickness of the insulating film is preferably, but not limited to, 0.005 μm or more and 10.000 μm or less (i.e., from 0.005 μm to 10.000 μm), more preferably 0.030 μm or more and 1.500 μm or less (i.e., from 0.030 μm to 1.500 μm). The insulating film with a thickness of 10 μm or less can have a greatly reduced influence on the characteristics of the electronic component.

The thickness of the insulating film can be measured by observing a cross section of the insulating film cut in the thickness direction with a scanning electron microscope (SEM).

The insulating film may contain a pigment, a silicone flame retardant, a surface treatment agent, such as a silane coupling agent or a titanate coupling agent, an antistatic agent, and the like, in addition to glass.

### [Cu Segregate]

In one embodiment of an electronic component according to the present disclosure, the Cu segregate containing the Cu element is in contact with the base and the insulating film at the interface between the base and the insulating film.

The Cu segregate at the interface between the base and the insulating film enhances the adhesion between the base and the insulating film.

The Cu segregate may be present anywhere on the base and is preferably present at the grain boundary of the ceramic of the base. The grain boundary of the ceramic of the base has a concave shape on the surface of the base. Thus, the Cu segregate at the grain boundary with the concave shape causes an anchoring effect, which further improves the adhesion between the Cu segregate and the base.

The Cu segregate may have any composition that contains at least the Cu element, and is, for example, Cu, CuO, or Cu₂O. The Cu segregate may contain glass.

A plurality of Cu segregates may be present at the interface between the base and the insulating film.

A plurality of Cu segregates at the interface between the base and the insulating film can further enhance the adhesion between the base and the insulating film.

The presence of Cu segregates at the interface between the base and the insulating film can be confirmed by observing the interface between the base and the insulating film in a section of the electronic component by scanning electron microscope-energy dispersive X-ray spectrometry (SEM-EDX).

The shape of a Cu segregate near the interface between the base and the insulating film can be determined by measuring the concentration distribution of the Cu element from an elemental mapping image in the vicinity of the interface between the base and the insulating film obtained by SEM-EDX.

In a base made of ferrite, the base contains an Fe element as a main component, the Cu segregate contains a Cu element as a main component, and the insulating film contains a Si element as a main component. Thus, the base, the Cu segregate, and the insulating film in an elemental mapping image can be distinguished by comparing the concentrations of the Fe element, the Cu element, and the Si element in the elemental mapping image.

In a base made of a ceramic other than ferrite, the base, the Cu segregate, and the insulating film in an elemental mapping image can be distinguished by comparing the concentrations of the element of the main component of the ceramic, the Cu element, and the Si element. For example, the main component of the ceramic may be an Al element in a base made of alumina, a Ti element or a Ba element in a base made of barium titanate for a capacitor, or a Zn element in a base made of a Zn ceramic for a thermistor.

The Cu segregate may have any shape and may be granular, wedge-shaped, or layered.

The shape of the Cu segregate can be determined by the value of the aspect ratio and by whether or not the Cu segregate protrudes toward the base.

The aspect ratio of the Cu segregate is represented by the ratio [La/Lb] of a length La to a length Lb (hereinafter also referred to as an aspect ratio), wherein La denotes the length of the Cu segregate in the direction in which the interface between the base and the insulating film extends, and Lb denotes the length of the Cu segregate in a direction perpendicular to the direction of La. The length Lb corresponds to the distance between two imaginary lines that pass through the points on the Cu segregate closest to the base and farthest from the base and that are parallel to the direction in which the interface between the base and the insulating film extends.

A Cu segregate with a shape protruding toward the base has a wedge shape regardless of the aspect ratio of the Cu segregate.

When the Cu segregate does not have a wedge shape, the shape with an aspect ratio of 3 or less is a granular shape, and the shape with an aspect ratio of more than 3 is a layer shape.

In the Cu segregate with a wedge shape, the Cu segregate excluding the portion protruding toward the base may have a granular shape or a layer shape.

A layered Cu segregate is present only in a portion of the interface between the base and the insulating film and does not cover the entire interface between the base and the insulating film.

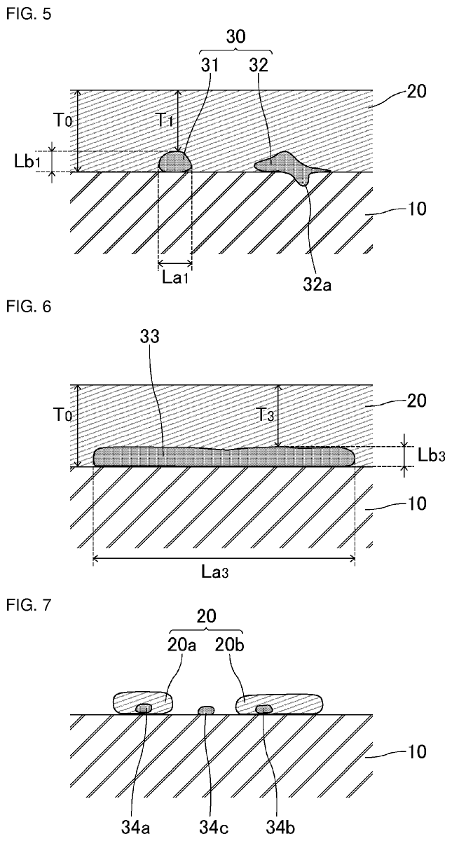

FIG. 5 is a schematic cross-sectional view of one example of the state of an interface between a base and an insulating film in one embodiment of an electronic component according to the present disclosure.

As illustrated in FIG. 5, a Cu segregate 30 (31, 32) is present at the interface between the base 10 and the insulating film 20 and is in contact with the base 10 and the insulating film 20. A portion without the Cu segregate 30 in the insulating film 20 (the insulating film 20 immediately above the base 10) has a thickness corresponding to the length indicated by the double-headed arrow T₀. The thickness T₀ of the insulating film 20 may vary from place to place.

In FIG. 5, it can be said that a plurality of Cu segregates are present at the interface between the insulating film 20 and the base 10.

The length of the Cu segregate 31 in the direction in which the interface between the base 10 and the insulating film 20 extends (hereinafter also referred to as a transverse direction) is the length indicated by the double-headed arrow La₁. The length of the Cu segregate 31 in the direction perpendicular to the transverse direction (hereinafter also referred to as a longitudinal direction) is the length indicated by the double-headed arrow Lb₁. The Cu segregate 31 has an aspect ratio [La₁/Lb₁] of approximately 1.4. Thus, the Cu segregate 31 has a granular shape.

The thickness of the Cu segregate 31 is the length indicated by the double-headed arrow Lb₁, and the thickness of the insulating film 20 immediately above the Cu segregate 31 is the length indicated by the double-headed arrow T₁.

The Cu segregate 31 has a shape that does not protrude toward the base 10. In FIG. 5, the sum of the thickness Lb₁ of the Cu segregate 31 and the thickness T₁ of the insulating film 20 immediately above the Cu segregate 31 is equal to the thickness T₀ of the insulating film 20.

The thickness T₀ of the insulating film 20 is larger than the thickness T₁ of the insulating film 20 immediately above the Cu segregate 31. The thickness T₀ of the insulating film 20 larger than the thickness T₁ of the insulating film 20 immediately above the Cu segregate 31 results in the insulating film with reduced surface unevenness caused by the presence of the Cu segregate and the insulating film with improved surface smoothness.

The Cu segregate 32 has a protrusion 32a protruding toward the base 10. It can therefore be said that the Cu segregate 32 has a wedge shape regardless of the aspect ratio.

Whether or not a Cu segregate protrudes toward the base is determined by estimating the shape of the base surface without the Cu segregate in a portion with the Cu segregate from the shape of the base surface in a portion without the Cu segregate on the surface of the base. The presence of a Cu segregate inside the estimated base surface (on the base side) is considered that the Cu segregate protrudes toward the base.

A Cu segregate may protrude not toward the base but toward the insulating film. The shape of a Cu segregate protruding not toward the base but only toward the insulating film is determined to be granular or layered from the aspect ratio.

FIG. 6 is a schematic cross-sectional view of another example of the state of an interface between a base and an insulating film in one embodiment of an electronic component according to the present disclosure.

A Cu segregate 33 has a length indicated by the double-headed arrow La₁ in the transverse direction and a length indicated by the double-headed arrow Lb₃ in the longitudinal direction. The aspect ratio [La₃/Lb₃] is approximately 10. Thus, the Cu segregate 33 has a layer shape.

A layered Cu segregate is present only in a portion of the interface between the base and the insulating film and does not cover the entire interface between the base and the insulating film.

The thickness of the Cu segregate 33 is the length indicated by the double-headed arrow Lb₃, and the thickness of the insulating film 20 immediately above the Cu segregate 33 is the length indicated by the double-headed arrow T₃.

The Cu segregate 33 has a shape that does not protrude toward the base 10. In FIG. 6, the sum of the thickness Lb₃ of the Cu segregate 33 and the thickness T₃ of the insulating film 20 immediately above the Cu segregate 33 is equal to the thickness T₀ of the insulating film 20.

The thickness T₀ of the insulating film 20 is larger than the thickness T₃ of the insulating film 20 immediately above the Cu segregate 33.

The shape of a Cu segregate is related to the thickness of the insulating film immediately above the Cu segregate.

When the insulating film immediately above a Cu segregate has a thickness of less than 0.5 μm, the Cu segregate tends to have a granular or wedge shape.

On the other hand, when the insulating film immediately above a Cu segregate has a thickness of 0.5 μm or more, the Cu segregate tends to have a layer shape.

In determining the shape of a Cu segregate, a portion where the Cu segregate is mixed with the glass constituting the insulating film is also regarded as a portion of the Cu segregate. Thus, the shape is determined as one Cu segregate including the portion where the Cu segregate is mixed with the glass constituting the insulating film. The boundary between a Cu segregate and the insulating film can be identified by elemental mapping of a Si element and a Cu element using SEM-EDX.

The shape and aspect ratio of a Cu segregate and the thickness of the insulating film immediately above the Cu segregate can be measured by SEM-EDX.

The shape and aspect ratio of a Cu segregate are determined for each Cu segregate. The thickness of the insulating film immediately above a Cu segregate is defined, from a SEM-EDX image taken such that the Cu segregate and the insulating film are included in one field of view, as the minimum value of the length of each Cu segregate from a point on the upper surface of the Cu segregate to a point on the top surface of the insulating film immediately above the Cu segregate in the longitudinal direction. The thickness of the insulating film in a portion with no Cu segregate is the average value of the lengths from the surface of the base to the top surface of the insulating film measured at three positions. The selected three positions are points with the maximum length, the minimum length, and the intermediate length from the surface of the base to the top surface of the insulating film in visual observation.

The surface of the base may be covered with a plurality of insulating films. The base 10 illustrated in FIGS. 1 and 2 and the base 11 illustrated in FIGS. 3 and 4 are examples covered with a plurality of insulating films.

The plurality of insulating films may have different compositions or the same composition.

When the surface of the base is covered with a plurality of insulating films, a Cu segregate may be present at the interface between each of the insulating films and the base. A portion of the Cu segregate is not necessarily covered with the insulating film. Such a Cu segregate is exposed on the surface of the base.

The insulating film may be scattered on the surface of the base.

An example in which the insulating film is scattered on the surface of the base is described below with reference to FIG. 7.

FIG. 7 is a schematic cross-sectional view of still another example of the state of an interface between a base and an insulating film in one embodiment of an electronic component according to the present disclosure.

Two insulating films 20a and 20b are provided on the surface of the base 10 in FIG. 7. Cu segregates 34a and 34b are present at the interfaces between the insulating films 20a and 20b and the base 10, respectively.

A portion not covered with the insulating film 20 is present on the surface of the base 10, and the surface of the base 10 is exposed in this portion. A Cu segregate 34c is present in a portion of the surface of the base 10 not covered with the insulating film 20. Thus, the Cu segregate 34c is exposed on the surface of the base 10.

A Cu segregate on the surface of the base constituting an electronic component according to the present disclosure promotes plating growth. An insulating film covering a Cu segregate can reduce the promotion of plating growth caused by the Cu segregate and can suppress plating growth in an unintended region on the surface of the base.

From the above perspective, an insulating film covering a Cu segregate is preferably formed around an outer electrode to be plated. An insulating film formed around an outer electrode to be plated can reduce the formation of plating in the region where the insulating film is formed.

### [Outer Electrode]

One embodiment of an electronic component according to the present disclosure has an outer electrode in any form.

The outer electrode is, for example, a combination of an underlying electrode layer and a covering layer formed on the surface thereof, a metal sheet, or a lead terminal. The underlying electrode layer may be an electrode formed by applying a glass paste containing glass and a conductor to the surface of the base and baking the glass paste or may be an electrode formed directly on the surface of the base by sputtering or plating.

The glass constituting the insulating film can be suitably used as glass in the underlying electrode layer.

The underlying electrode layer preferably has a conductor portion containing a conductor and a glass portion containing glass.

The conductor portion preferably contains, as a conductor, at least one metal element selected from the group consisting of a Ni element, a Sn element, a Pd element, a Au element, a Ag element, a Pt element, a Bi element, a Cu element, and a Zn element. Furthermore, it is preferable to contain electrically conductive particles containing these elements.

The conductor portion preferably contains a Ag element as a conductor. The Ag element has high electrical conductivity. An underlying electrode layer that contains a Ag element as a conductor can be easily formed.

The average particle size of the electrically conductive particles is preferably, but not limited to, 0.5 μm or more and 10 μm or less (i.e., from 0.5 μm to 10 μm).

The weight ratio of the electrically conductive particles in the underlying electrode layer is preferably, but not limited to, 71% by weight or more and 98% by weight or less (i.e., from 71% by weight to 98% by weight).

The weight ratio of the glass in the underlying electrode layer is preferably 2% by weight or more and 15% by weight or less (i.e., from 2% by weight to 15% by weight).

When the weight ratio of the glass in the underlying electrode layer is 15% by weight or less, the underlying electrode layer does not have too high a resistance value. When the weight ratio of the glass in the underlying electrode layer is 2% by weight or more, the underlying electrode layer can have an increased density, and a plating solution and moisture are prevented from entering the underlying electrode layer or entering the base through the underlying electrode layer.

The covering layer is preferably, for example, a plating layer provided on the surface of the underlying electrode layer.

The plating layer preferably contains at least one metal selected from the group consisting of Cu, Ni, Sn, Pd, Au, Ag, Pt, Bi, and Zn. The plating layer may be a single layer or two or more layers. The plating layer is more preferably a layer including a nickel plating layer and a tin plating layer provided on the underlying electrode layer. The nickel plating layer prevents water from entering the base, and the tin plating layer improves the mountability of the electronic component.

A Cu segregate may be present at the interface between the base and the underlying electrode layer (preferably the interface between the base and the glass portion).

A Cu segregate at the interface between the base and the underlying electrode layer enhances the adhesion between the base and the underlying electrode layer.

The electronic component according to the present embodiment has high adhesion between the base and the insulating film. The electronic component according to the present embodiment is not limited to a multilayer coil component or a wound coil component and may be any component including, as the base, a ceramic containing a Cu element.

### [Method for Producing Electronic Component]

### First Embodiment

A first embodiment of a method for producing an electronic component according to the present disclosure includes a ceramic sheet preparation step of preparing a ceramic sheet by shaping a ceramic raw material containing a Cu element into a sheet, a conductor pattern formation step of forming a conductor pattern to be a via-hole and a coil pattern on the ceramic sheet, a multilayer body preparation step of preparing a multilayer body by stacking the ceramic sheets, a firing step of firing the multilayer body to prepare a ceramic base, and an insulating film formation step of forming an insulating film containing glass on the surface of the base.

### [Ceramic Sheet Preparation Step]

In the ceramic sheet preparation step, a ceramic raw material containing a Cu element is shaped into a sheet.

When a ferrite raw material is used as the ceramic raw material, a powdered ferrite raw material can be prepared, for example, by weighing and wet-blending Fe₂O₃, ZnO, CuO, and NiO at a predetermined ratio, and then pulverizing, drying, and calcining the mixture.

Subsequently, a ceramic raw material, an organic binder, such as a poly(vinyl butyral) resin, an organic solvent, such as ethanol or toluene, and the like are mixed and then pulverized to prepare a ceramic slurry. Next, the ceramic slurry is shaped into a sheet with a predetermined thickness by a doctor blade method or the like and is then punched out into a predetermined shape to prepare a ceramic sheet.

The ceramic raw material preferably has a Cu element content of 6% by mole or more and 10% by mole or less (i.e., from 6% by mole to 10% by mole).

At a higher Cu element content of the ceramic raw material, a Cu segregate is more likely to be formed on the surface of the base.

The ceramic sheet preferably has an organic binder content of 25% by weight or more and 35% by weight or less (i.e., from 25% by weight to 35% by weight).

The organic binder in the ceramic sheet contains carbon, which combines with oxygen in the atmosphere during firing and decreases the oxygen concentration. Thus, a higher organic binder content tends to result in a lower oxygen concentration in the firing step and consequently a higher occurrence of a Cu segregate on the surface of the base.

The thickness of the ceramic sheet is preferably, but not limited to, 15 μm or more and 50 μm or less (i.e., from 15 μm to 50 μm).

### [Conductor Pattern Formation Step]

In the conductor pattern formation step, an electrically conductive paste, such as an Ag paste, is applied to each ceramic sheet by a screen printing method or the like to form a conductor pattern. To form a conductor pattern to be a via-conductor, a via-hole is formed in advance by irradiating a predetermined portion of a ceramic sheet with a laser and is filled with an electrically conductive paste.

### [Multilayer Body Preparation Step]

The ceramic sheets are stacked and are then pressure-bonded by warm isostatic pressing (WIP) or the like to prepare a multilayer body.

The number of ceramic sheets to be stacked is preferably, but not limited to, 30 or more and 100 or less (i.e., from 30 to 100).

### [Firing Step]

In the firing step, the multilayer body is fired to prepare a base.

The firing conditions are such that a Cu segregate precipitates on the surface of the base.

Whether or not a Cu segregate is formed on the surface of the base depends not only on the composition of the ceramic raw material but also on the amount of carbon in the multilayer body, the firing temperature (maximum temperature), the heating rate, the firing atmosphere, the material of a firing furnace, and the like. When these conditions are appropriately selected, a Cu segregate precipitates on the surface of the base.

Thus, under inappropriate firing conditions, even using the ceramic raw material with the same composition, a Cu segregate does not precipitate on the surface of the base.

The firing temperature (maximum temperature) in the firing step is preferably 1000° C. or more and 1300° C. or less (i.e., from 1000° C. to 1300° C.).

At a firing temperature (maximum temperature) of 1000° C. or more in the firing step, a Cu segregate tends to be formed on the surface of the base.

The oxygen concentration in the firing step is preferably 15% by volume or less, more preferably 5% by volume or less. At an oxygen content of 15% by volume or less in the firing atmosphere, a Cu segregate tends to be formed on the surface of the base.

The balance gas in the firing step is preferably nitrogen or argon.

The heating rate in the firing step is preferably 10° C./min or less.

A shorter time to reach the firing temperature results in a higher occurrence of a Cu segregate on the surface of the base.

A furnace material constituting a firing furnace for firing the multilayer body in the firing step is preferably a high-density material, such as a mixture of alumina and silicon.

When a furnace material constituting a firing furnace is composed of a high-density material, a Cu segregate tends to be formed.

### [Insulating Film Formation Step]

In the insulating film formation step, an insulating film containing glass is formed on the surface of the base prepared in the firing step.

The insulating film can be formed by applying a paste containing glass (hereinafter referred to as a glass paste) to the surface of the base and firing (baking) the paste.

The glass paste may contain a resin and a dispersion medium in addition to the glass.

Examples of the glass include B—Si glass, Ba—B—Si glass, B—Si—Zn glass, B—Si—Zn—Ba glass, and B—Si—Zn—Ba—Ca—Al glass. In addition to these, alkali metal glasses, such as Na—Si glass, K—Si glass, and Li—Si glass; alkaline-earth metal glasses, such as Mg—Si glass, Ca—Si glass, Ba—Si glass, and Sr—Si glass; and Ti—Si glass, Zr—Si glass, and Al—Si glass can also be used.

The glass may be crystalline glass.

The average particle size of the glass constituting the glass paste is preferably, but not limited to, 0.01 μm or more and 4.00 μm or less (i.e., from 0.01 μm to 4.00 μm).

A larger average particle size of the glass constituting the glass paste tends to result in the glass paste with lower fluidity during baking and the insulating film with a larger thickness. Thus, a layered Cu segregate tends to be formed.

On the other hand, a smaller average particle size of the glass constituting the glass paste tends to result in the glass paste with higher fluidity during baking and the insulating film with a smaller thickness. Thus, a granular or wedge-shaped Cu segregate tends to be formed.

The glass paste applied to the surface of the base is dried. The glass paste may be dried under any conditions, for example, by heating at 150° C. for approximately 30 minutes.

When the glass paste is applied to the surface of the base multiple times, it is preferable to repeat the application and drying of the glass paste. The application and drying of the glass paste may be combined with baking described later, and the combination can also be repeated to form the insulating film.

The temperature at which the insulating film is formed (baking temperature) is preferably, but not limited to, 750° C. or more and 900° C. or less (i.e., from 750° C. to 900° C.).

A baking temperature of 750° C. or more and 900° C. or less (i.e., from 750° C. to 900° C.) tends to result in a higher occurrence of a Cu segregate on the surface of the base. Furthermore, a Cu segregate and glass contained in the insulating film can easily form a mixture, which can improve the adhesion between the base and the insulating film.

The baking is preferably performed in a nonoxidizing atmosphere.

Baking in a nonoxidizing atmosphere at 825° C. or more can promote the segregation of Cu on the surface of the base. This can further improve the adhesion between the base and the insulating film.

The insulating film may be formed on the surface of the base not only by the method for applying and firing the glass paste described above but also by a sputtering method, an electron beam evaporation method, a thermal CVD method, a plasma CVD method, a spray method, a dipping method, a dip spin coating method, a sol-gel method, or a combination thereof.

The method for producing the base may be a method other than the sheet lamination method described above.

The method other than the sheet lamination method is, for example, a printing lamination method (build-up method). In addition to the method described above, a method using photolithography can also be used as a method for forming wiring or a via on a sheet surface.

The above step may be followed by an outer electrode formation step of forming an outer electrode on the surface of the base.

### [Outer Electrode Formation Step]

In the outer electrode formation step, an outer electrode is formed on the surface of the base.

The outer electrode formation step is, for example, a method for performing nickel plating and tin plating on the surface of the base in this order to form a nickel plating and tin plating layer.

In the outer electrode formation step, before the step of forming a plating layer, a glass paste containing glass and electrically conductive particles may be applied to the surface of the base and fired (baked) to form an underlying electrode layer, and a nickel plating and tin plating layer to be a covering layer may be formed on the surface of the underlying electrode layer.

An electronic component with a conductor layer inside a base, for example, as illustrated in FIGS. 1 and 2 can be produced by the steps described above.

### Second Embodiment

A second embodiment of a method for producing an electronic component according to the present disclosure includes a base preparation step of shaping a ceramic raw material containing a Cu element to prepare a ceramic base, an insulating film formation step of forming an insulating film on the surface of the base, and a coil formation step of winding a winding wire to be a coil around the surface of the base.

### [Base Preparation Step]

The ceramic raw material used in the first embodiment of a method for producing an electronic component according to the present disclosure can be suitably used as a ceramic raw material used in the base preparation step.

A known powder shaping method can be used as a method for shaping a ceramic raw material into a predetermined shape. A resin, a binder, or the like may be added to the ceramic raw material as required. A green body prepared by shaping a ceramic raw material is fired to prepare a base. The green body is fired under the conditions that a Cu segregate is formed on the surface of the base.

The base prepared by this method is a base with no conductor layer inside.

### [Insulating Film Formation Step]

In the insulating film formation step, an insulating film is formed on the surface of the base prepared in the firing step.

The insulating film formation step in the second embodiment of a method for producing an electronic component according to the present disclosure is the same as the insulating film formation step in the first embodiment of an electronic component according to the present disclosure.

### [Coil Formation Step]

In the coil formation step, a winding wire to be a coil is wound around the surface of the base.

The number of windings (turns) of the winding wire and the diameter of the winding wire may be appropriately changed in accordance with the specification required for the electronic component.

An electronic component according to an embodiment of the present disclosure is produced through these steps.

The second embodiment of a method for producing an electronic component according to the present disclosure may include an outer electrode formation step of forming an outer electrode on the surface of the base.

The outer electrode formation step in the second embodiment of a method for producing an electronic component according to the present disclosure is the same as the outer electrode formation step in the first embodiment of a method for producing an electronic component according to the present disclosure.

In this case, the outer electrode formation step may be performed before the coil formation step, and each end of the winding wire to be a coil may be coupled to an outer electrode in the coil formation step.

The winding wire to be a coil may be coupled to an outer electrode by any method, for example, by a bonding method utilizing thermocompression bonding.

An electronic component with a winding wire to be a coil wound around a base, for example, as illustrated in FIGS. 3 and 4 can be produced by these steps.

### EXAMPLES

One embodiment of an electronic component according to the present disclosure is more specifically disclosed in the following examples. The present disclosure is not limited to these examples.

### Example 1

### [Base Preparation Step]

A ferrite raw material prepared so as to have a constant Fe content, a Ni/Zn mole ratio of 2.3, and a Cu content of 8% by mole was shaped in a barbell shape having a winding wire portion and a flange to prepare a green body.

The green body was fired at 1100° C. for 1 hour to prepare a ceramic base.

The atmosphere during firing was at atmospheric pressure and at an oxygen partial pressure of 10% by volume.

As illustrated in FIGS. 1 and 2, the shape of the base was an approximately rectangular parallelepiped shape with a first end face and a second end face that face each other in the length direction, a first side surface and a second side surface that face each other in the width direction, and an upper surface and a bottom surface that face each other in the thickness direction.

### [Insulating Film Formation Step]

A glass paste was prepared by mixing a glass frit (borosilicate glass) and a solvent (terpineol). A half of the base in the width direction was immersed in the glass paste with the first side surface of the base facing downward and was then dried at 150° C. for 30 minutes. The base was then turned upside down, and a half of the base in the width direction was immersed in the glass paste with the second side surface of the base facing downward and was then dried at 150° C. for 30 minutes. Finally, baking was performed at 650° C. for 10 minutes to form an insulating film, thereby producing an electronic component according to Example 1. The segregation amount of Cu segregate is more easily increased at a higher baking temperature. Thus, the baking temperature is preferably 750° C. or more, and the fluidity of a Cu segregate is improved at a baking temperature of 850° C. or more.

As in FIG. 1, an insulating film entirely covering the first side surface of the base and partially covering the first end face, the second end face, the upper surface, and the bottom surface of the base and an insulating film entirely covering the second side surface of the base and partially covering the first end face, the second end face, the upper surface, and the bottom surface of the base were formed on the surface of the base constituting the electronic component according to Example 1.

### Example 2 and Comparative Examples 1 to 3

Electronic components according to Example 2 and Comparative Examples 1 to 3 were produced in the same manner as in Example 1 except that the Cu content was changed to 6% by mole, 4% by mole, 1% by mole, and 0% by mole without changing the Fe content and the Ni/Zn mole ratio of the ferrite raw material. The base of each of the example and the comparative examples had approximately the same sintered density as Example 1.

### Comparative Example 4

An electronic component according to Comparative Example 4 was produced in the same manner as in Example 1 except that the firing temperature (maximum temperature) of the green body was changed to 950° C. or less without changing the composition of the ferrite raw material. The base of Comparative Example 4 had approximately the same sintered density as Example 1.

### [Measurement of Cu Content of Base]

The Cu element content of the base measured by WD-XRF described above was the same as the Cu element content of the ferrite raw material in all the examples and comparative examples.

### [Observation by SEM-EDX]

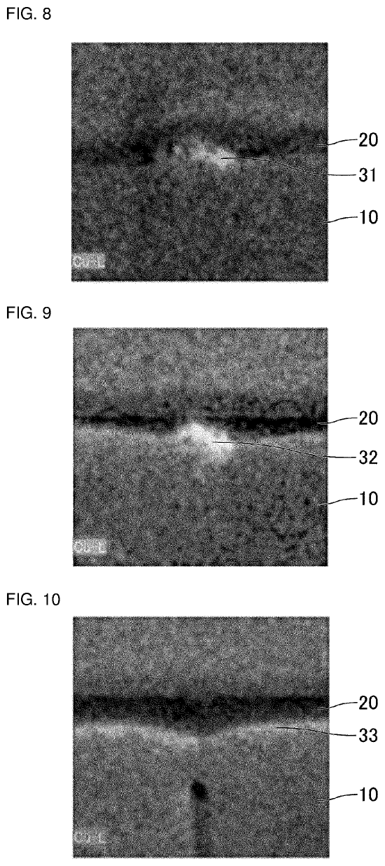

In the electronic component according to Example 2, three portions near the interface between the base and the insulating film were observed by SEM-EDX for elemental mapping of Cu. FIGS. 8, 9, and 10 show the results.

In the electronic components according to Example 1 and Comparative Examples 1 to 4, the vicinity of the interface between the base and the insulating film was observed by SEM-EDX. In the electronic component according to Example 1, a Cu segregate in contact with the base and the insulating film was observed at the interface between the base and the insulating film. In contrast, in the electronic components according to Comparative Examples 1 to 4, no Cu segregate was observed.

FIG. 8 is an elemental mapping image of Cu at the interface between the base and the insulating film of the electronic component according to Example 2.

The results in FIG. 8 showed that, in the electronic component according to Example 2, a region with a high concentration of the Cu element (a Cu segregate 31) was present at the interface between the base 10 and the insulating film 20. The Cu segregate 31 had an aspect ratio of 2.0. This showed that a granular Cu segregate 31 was present in the SEM-EDX elemental mapping image in FIG. 8. The insulating film 20 immediately above the Cu segregate 31 had a thickness of 0.03 μm.

FIG. 9 is an elemental mapping image of Cu at the interface between the base and the insulating film of the electronic component according to Example 2. The SEM-EDX measurement position in FIG. 9 is different from the SEM-EDX measurement position in FIG. 8.

The results in FIG. 9 showed that, in the electronic component according to Example 2, a region with a high concentration of the Cu element (a Cu segregate 32) was present at the interface between the base 10 and the insulating film 20. The Cu segregate 32 protrudes toward the base 10. This showed that a wedge-shaped Cu segregate 32 was present in the SEM-EDX elemental mapping image in FIG. 9. The insulating film 20 immediately above the Cu segregate 32 had a thickness of 0.13 μm.

FIG. 10 is an elemental mapping image of Cu at the interface between the base and the insulating film of the electronic component according to Example 2. The SEM-EDX measurement position in FIG. 10 is different from the SEM-EDX measurement position in FIG. 8 and from the SEM-EDX measurement position in FIG. 9.

The results in FIG. 10 showed that, in the electronic component according to Example 2, a layered Cu segregate 33 was present at the interface between the base 10 and the insulating film 20. The insulating film 20 immediately above the Cu segregate 33 had a thickness of 0.5 μm.

The results of FIGS. 8, 9, and 10 showed that a plurality of Cu segregates with different shapes were present at the interface between the insulating film and the base in the electronic component.

### [Measurement of Load Capacity (Scratch Test)]

The presence or absence of separation of an insulating film in each base was examined with an ultra-thin film scratch tester (CSR5000 manufactured by Rhesca Corporation) by moving a diamond indenter (tip R: 5 μm) by 150 μm while pressing the diamond indenter against the insulating film at a predetermined load. The load was increased from 5 mN to 60 mN in 5 mN increments. The highest load at which no separation occurred is shown as load capacity in Table 1. A load capacity of 40 mN or more can be judged that the adhesion between the base and the insulating film is sufficiently high.

TABLE 1

| | | | Comparative | Comparative | Comparative | Comparative |
|---|---|---|---|---|---|---|
| | Example 1 | Example 2 | example 1 | example 2 | example 3 | example 4 |
| Cu content of ferrite | 8 | 6 | 4 | 1 | 0 | 8 |
| sintered body [mol %] | | | | | | |
| Load capacity [mN] | 55 | 40 | 35 | 15 | 15 | 35 |

The results in Table 1 showed that the electronic components according to the embodiments of the present disclosure had high adhesion between the base and the insulating film.

An electronic component according to an embodiment of the present disclosure can be suitably used as a component, such as an inductor, an antenna, a noise filter, an electromagnetic wave absorber, an LC filter combined with a capacitor, a wound core, or the like.

What is claimed is:

1. An electronic component comprising:
a ceramic base including a Cu element;
an insulating film including glass and at least partially covering a surface of the base; and
a Cu segregate including a Cu element,
wherein the Cu segregate is in contact with the base and the insulating film at an interface between the base and the insulating film.

2. The electronic component according to claim 1, wherein
the Cu segregate partially protrudes toward the base and has a wedge shape.

3. The electronic component according to claim 1, wherein
the Cu segregate has a granular shape with a ratio [La/Lb] of a length La to a length Lb of 3 or less, wherein La denotes a length of the Cu segregate in a direction in which the interface between the base and the insulating film extends, and Lb denotes a length of the Cu segregate in a direction perpendicular to the direction of La.

4. The electronic component according to claim 2, wherein
the insulating film immediately above the Cu segregate has a thickness of less than 0.5 μm.

5. The electronic component according to claim 1, wherein
the Cu segregate is a layer with a ratio [La/Lb] of a length La to a length Lb of more than 3, wherein La denotes a length of the Cu segregate in a direction in which the interface between the base and the insulating film extends, and Lb denotes a length of the Cu segregate in a direction perpendicular to the direction of La.

6. The electronic component according to claim 5, wherein
the insulating film immediately above the Cu segregate has a thickness of 0.5 μm or more.

7. The electronic component according to claim 1, wherein
a plurality of the Cu segregates are at the interface between the base and the insulating film.

8. The electronic component according to claim 1, wherein
the insulating film immediately above the base has a larger thickness than the insulating film immediately above the Cu segregate.

9. The electronic component according to claim 1, wherein
a surface of the base is covered with a plurality of the insulating films.

10. The electronic component according to claim 3, wherein
the insulating film immediately above the Cu segregate has a thickness of less than 0.5 μm.

11. The electronic component according to claim 2, wherein
a plurality of the Cu segregates are at the interface between the base and the insulating film.

12. The electronic component according to claim 3, wherein
a plurality of the Cu segregates are at the interface between the base and the insulating film.

13. The electronic component according to claim 4, wherein
a plurality of the Cu segregates are at the interface between the base and the insulating film.

14. The electronic component according to claim 5, wherein
a plurality of the Cu segregates are at the interface between the base and the insulating film.

15. The electronic component according to claim 2, wherein
the insulating film immediately above the base has a larger thickness than the insulating film immediately above the Cu segregate.

16. The electronic component according to claim 3, wherein
the insulating film immediately above the base has a larger thickness than the insulating film immediately above the Cu segregate.

17. The electronic component according to claim 4, wherein
the insulating film immediately above the base has a larger thickness than the insulating film immediately above the Cu segregate.

18. The electronic component according to claim 2, wherein
a surface of the base is covered with a plurality of the insulating films.

19. The electronic component according to claim 3, wherein
a surface of the base is covered with a plurality of the insulating films.

20. The electronic component according to claim 4, wherein
a surface of the base is covered with a plurality of the insulating films.
